(19) United States
(12) Patent Application Publication
(10) Pub. No.: US 2012/0143994 A1
(43) Pub. Date: Jun. 7, 2012

(54) SELECTIVELY RECEIVING MEDIA CONTENT

(75) Inventors: George Calcev, Hoffman Estates, IL (US); Kevin L. Baum, Rolling Meadows, IL (US); Jeffrey D. Bonta, Arlington Heights, IL (US); Benedito J. Fonseca, JR., Glen Ellyn, IL (US)

(73) Assignee: Motorola-Mobility, Inc., Libertyville, IL (US)

(21) Appl. No.: 12/959,645

(22) Filed: Dec. 3, 2010

(51) Int. Cl. G06F 15/16

(52) U.S. Cl. 709/219

(57) ABSTRACT

Disclosed are methods that associate “importance” information with chunks of a media presentation. An end-user device uses this information to intelligently manage resources when downloading or rendering the media presentation. An editor tags a chunk as important based on the contents of the chunk. The importance information includes a recommendation that this chunk be rendered at a higher-than-usual resolution and that the end-user device start downloading this chunk out of order. An advertiser recommends that an advertisement be rendered at a resolution high enough for the end user to view it appropriately. The importance information can include a recommended point at which to display the advertisement (e.g., between scenes in the media presentation). The end-user device can download advertisements before they are needed. Later, when the user requests a media presentation, an already downloaded advertisement is rendered while the initial chunks of the media presentation are downloaded.

### CROSS-REFERENCE TO RELATED APPLICATIONS

The present application is related to U.S. patent application Ser. Nos. 12/891,348 and 12/891,421, both filed on Sep. 27, 2010, and incorporated herein by reference in their entireties.

### FIELD OF THE INVENTION

The present invention is related generally to data-delivery systems and, more particularly, to systems that send or receive media presentations.

### BACKGROUND OF THE INVENTION

More and more users are downloading more and more media presentations to more and more devices. (Here, “media presentations” generally include just about any kind of digital content, and, more specifically, sound, video, and interactive files.) These media presentations are often enormous, and downloading them can consume a significant amount of available bandwidth and battery power on the user's device.

In order to manage download requests, download servers often divide a large media presentation into consecutive “chunks” where each chunk represents, for example, a few seconds of video. When a user wishes to consume a media presentation, his device begins by requesting a “playlist” for the presentation from the download server. (Note that here “consume” is meant as a general term for any type of human interaction with a medium. It can include watching television, listening to radio, playing a computer game, talking or texting on a telephone, interacting with a web site, and the like. To simplify the present discussion, a media consumer is generally called a “user” or a “viewer,” even when his medium of choice does not have a visual portion.) The playlist includes a list of descriptions of the chunks into which the presentation is segmented on that server (including alternative resolutions). With the playlist in hand, the user's device asks the server to download the first chunk of the presentation. While the user is viewing the first chunk, his device attempts to “keep ahead” of the user's viewing (and thus avoid “video freeze”) by requesting subsequent chunks of the presentation. The chunks are received and buffered on the user's device so that the user can continue to view the media presentation while subsequent chunks are still being delivered.

It is, however, very common for a user to request a media presentation, begin viewing it, and then decide not to view the entire file. This wastes bandwidth and battery power on the user's device as chunks are sent that are never viewed. Also, the user may fast-forward (or skip) through parts of a media presentation looking for scenes of interest. (For example, the user may fast-forward through much of a soccer game looking for an interesting goal.) This fast-forwarding can also waste bandwidth because the presentation is often downloaded at a maximum possible resolution (unless otherwise specified) even though it would be perfectly acceptable to display to the user the fast-forwarded parts at a much lower resolution. (Of course, downloading a media presentation at low resolution saves significant bandwidth and battery power compared to downloading the same presentation at a higher resolution.)

### BRIEF SUMMARY

The above considerations, and others, are addressed by the present invention, which can be understood by referring to the specification, drawings, and claims. According to aspects of the present invention, “importance” information is associated with each chunk (or at least with some chunks) of a media presentation. An end-user device, a download server, or a third-party server can use this importance information to more intelligently manage resources when downloading the media presentation.

Many different types of importance information may be used. For example, a human (or maybe electronic) editor can tag a chunk of a soccer game as important because that chunk includes a goal. The importance information given to the end-user device can then include a recommendation that this chunk be rendered at a higher-than-usual resolution and that the end-user device start downloading this high-resolution chunk out of order. Receiving this recommendation, the end-user device looks at its current (or predicts its future) bandwidth availability, and starts downloading the chunk before its natural place in the media presentation. That way, the high-resolution chunk is available when needed.

Similar techniques can be used in a very different situation. Because some download services are supported by advertising revenue, the service providers are very sensitive to the advertiser's needs. The advertiser may request that an advertisement be rendered at a resolution high enough for the end user to view it appropriately. The server can include a recommended minimum resolution for the chunk(s) of the advertisement as importance information for a media presentation during which the advertisement should appear. Instead of a minimum-resolution recommendation, the advertiser can request that the advertisement be seen in a resolution matching that of the surrounding media presentation, to prevent visual discontinuities. The end-user device receives the recommendations (along with other importance information) and responds accordingly by requesting the advertisement chunk(s) at a suitable resolution.

Unlike the chunks in a “normal” media presentation, an advertisement chunk does not have a “natural” temporal location at which it should be rendered. Thus, the importance information can include one or more recommended points at which to display the advertisement (e.g., between scenes in the media presentation).

If the advertisement consists of a number of chunks, then the importance information can note that fact, so that the end-user device does not begin rendering the advertisement until it has received at least a minimum number of the chunks in the advertisement.

Finally, the end-user device can take advantage of otherwise-unused bandwidth to download advertisements long before they are needed. Later, when the user requests the download of a media presentation, an already downloaded advertisement can be rendered to the user during the time that the initial chunks of the user-requested media presentation are being downloaded, thus preventing the boring “buffering” screen. The importance information of each advertisement can include characterizing information so that only appropriate advertisements are rendered before the beginning of the user-requested media presentation.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a generalized schematic of some of the devices shown in FIG. 1;

FIGS. 3a and 3b together form a flowchart of a method for an end-user device to use (and, in some embodiments, to gather) importance information;

FIGS. 4a and 4b together form a flowchart of a method for a server to provide media content and importance information;

FIG. 5 is a flowchart of a method for an edge server to use importance information for intelligent caching;

FIG. 6 is a chart illustrating variability in chunk sizes of a media presentation at a given resolution;

FIG. 7 is a flowchart of a method for using chunk-size information;

FIGS. 8a and 8b are graphs that show how intelligent use of chunk-size information can reduce video freeze;

FIGS. 9a and 9b together form a flowchart of a method for a server to provide media content and importance information; and

FIGS. 10a and 10b together form a flowchart of a method for an end-user device to use importance information.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

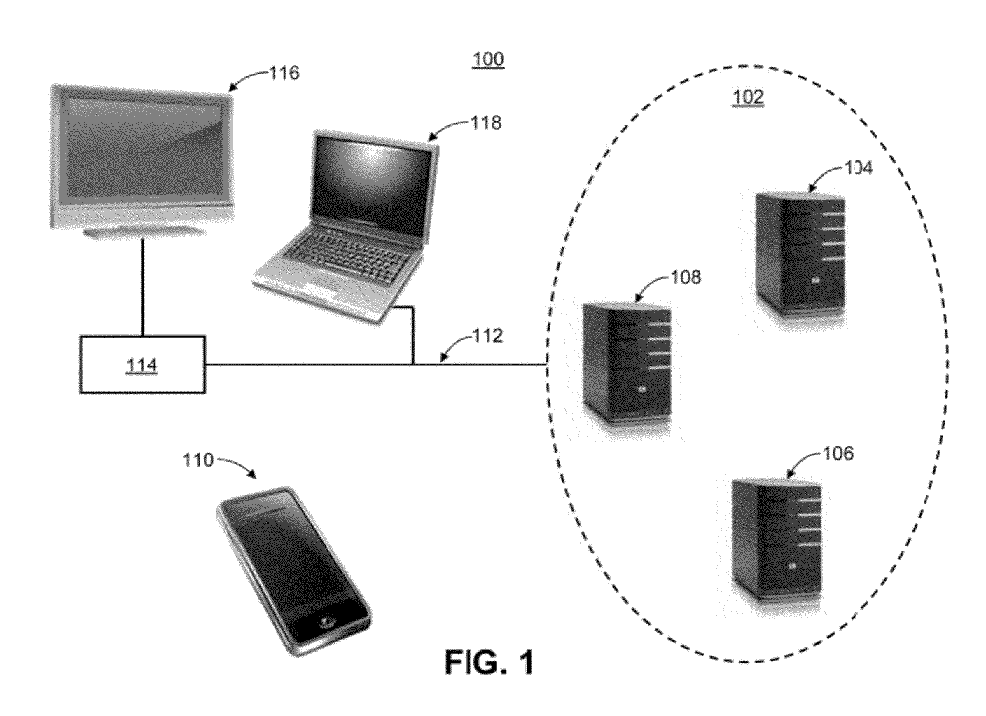

Aspects of the present invention may be practiced in the representative communications environment 100 of FIG. 1. Connected together via any or all of the various known networking technologies 102 are servers such as a download server 104, a third-party server 106, and an edge server 108. (The functions of each of these server types are discussed below.) For ease of illustration, only one of each type of server 104, 106, 108 is shown, but multiples of each can exist and can work together, as discussed below.

The servers 104, 106, 108 provide, via the networking technologies 102, media-download and related services to end-user devices. One example of an end-user device is a cellular telephone 110. This telephone 110 communicates wirelessly to a wireless base station (not shown but known in the art) to access the public switched telephone network, the Internet, or other networks to access the services provided by the servers 104, 106, 108.

Non-wireless end-user devices are supported by “wireline” network technologies (e.g., fiber, wire, and cable) 112. For example, a set-top box 114 generally receives television programs and provides a user interface (e.g., an interactive program guide) for selecting and viewing content from the cable provider. A digital video recorder (not shown) can store programming for later viewing. Video content may be viewed on a television monitor 116. In some situations, a laptop computer 118 accesses web-based services either wirelessly or via the wireline network 112. A home gateway, kiosk, digital sign, or media-restreaming device (not shown) are other possible end-user devices.

(A media-restreaming device transfers content between disparate types of networks. For example, it receives content from a cable system 112 and then transmits that content over a local radio link such as WiFi to the cellular telephone 110. The media-restreaming device usually operates in both directions to carry messages between the networks. In some embodiments, aspects of the present invention are practiced by a media-restreaming device.)

Wireless and wireline network technologies generally support two-way traffic: Media content and related information are delivered to the end-user devices 110, 114, 116, 118, and download requests go “up” to the servers 104, 106, 108.

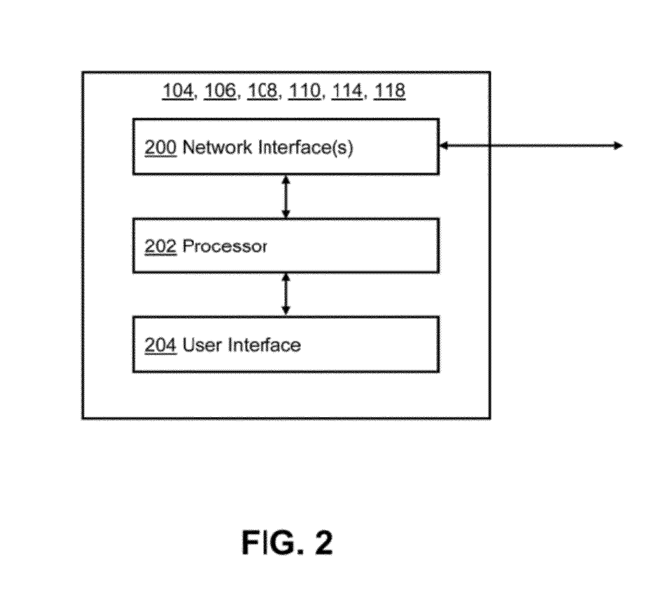

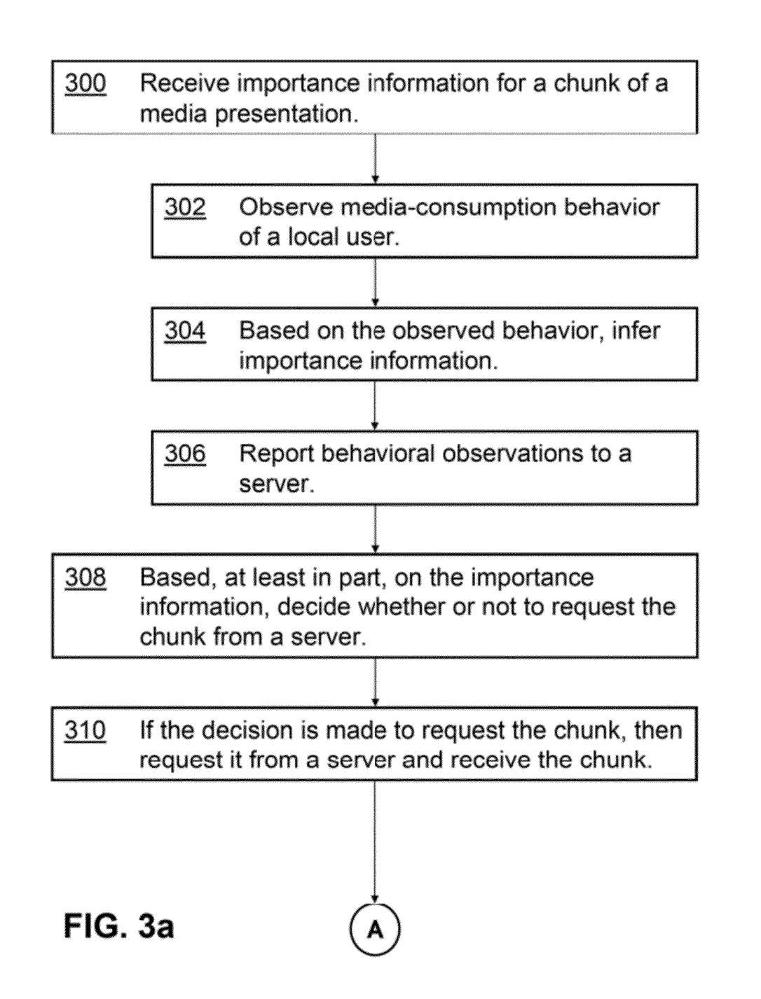

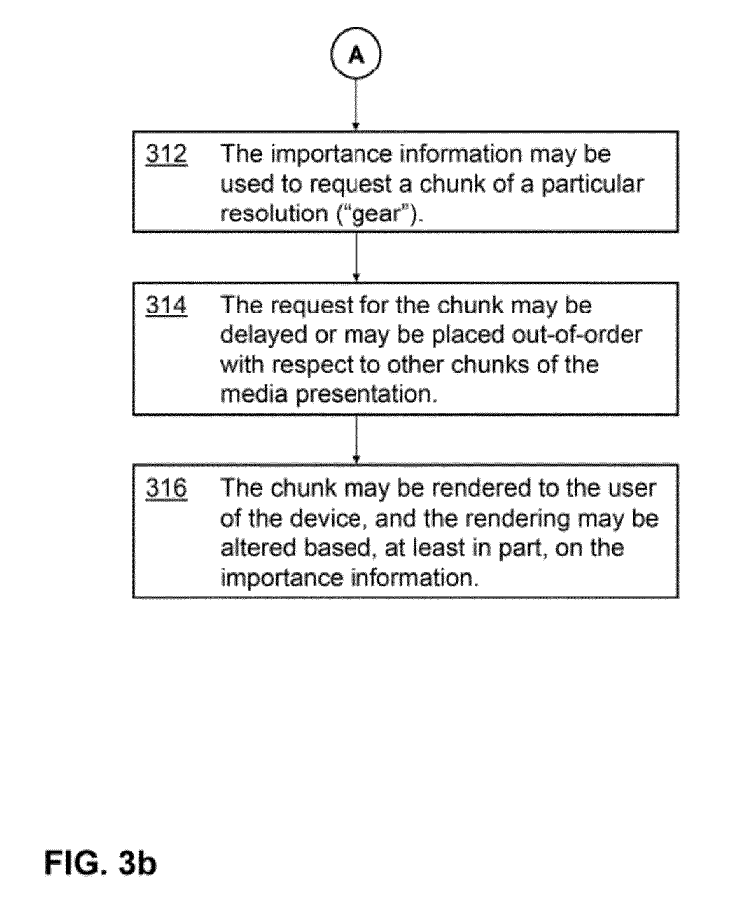

FIG. 2 shows the major components of a representative server 104, 106, 108 or end-user device 110, 114, 118. Network interfaces 200 send and receive media presentations, related information, and download requests. A processor 202 controls the operations of the device and, in particular, supports aspects of the present invention as illustrated in FIGS. 3 through 5, 9, and 10, discussed below. The user interface 204 supports a user's (or administrator's) interactions with the device. Specific uses of these components by specific devices are discussed as appropriate below.

The method of FIGS. 3a and 3b illustrates aspects of the present invention as embodied in an end-user device such as the cellular telephone 110 of FIG. 1. The method of these figures is not restricted to the telephone 110, but is applicable, with certain implementation modifications as appropriate, to all end-user devices.

(Note that all of the flowcharts are primarily intended to support the following discussion. The “steps” in the flowcharts are, in some embodiments and in some situations, optional and may be performed in a different order, if at all.)

In step 300 of FIG. 3a, the end-user device 110 receives “importance” information about a chunk of a media presentation. Many types of information are gathered under the umbrella term “importance.” A first class of importance information indicates, to some extent, whether or not a given chunk is worth viewing. For example, an editor can review a video of a soccer game and tag those portions of the game that are, in the editor's opinion, more interesting than other portions. A viewer pressed for time may not wish to watch the entire game but may be interested in viewing only those chunks tagged as important.

Statistics can be gathered about how many people actually watch which portions of a media presentation. If, for example, a large percentage of users stop requesting chunks of a music video after the first few seconds, then it can be inferred that at least the remainder (and possible the entirety) of the music video should be tagged as “unimportant.” Of course, different tags can specify in great detail exactly what is meant by the importance tag. In this scenario, the tag could give the demographic statistics of viewership, and each chunk can be tagged with the estimated or conditional probability that a viewer from a certain demographic population will be interested in and will watch this chunk.

“Importance” is meant to be broadly defined and can include just about any information that the end-user device 110 may use (in step 308, discussed below) to decide whether or not to download this chunk or to decide how to handle or render the chunk (in steps 312 through 316 of FIG. 3b, discussed below). Thus, another type of “importance” is rating information: A chunk can be tagged for various types of potentially offensive content.

Other types of importance information are possible and are contemplated. (See, in particular, the discussion accompanying steps 302 through 306.)

It should be noted that although in the present discussion, “importance” information is usually associated with a given chunk, that need not always be strictly true. A chunk might contain ten seconds of video, and a rating tag may only apply to a few seconds within that chunk. The tag can tell the user the exact scope of the importance information.

The end-user device 110 may receive the importance information from a number of sources. In one embodiment, the end-user device 110 receives a “playlist” from the download server 104. (The playlist may also be called a “manifest” or a “media-presentation description.”) The playlist contains information (such as the number of chunks, playing time duration of each chunk, supported resolutions, and the like) about a media presentation. The playlist can include the importance information or can include links to other sources for importance information. Instead of, or in addition to, the playlist, the end-user device 110 may receive importance information from a third-party server 106. (Here, the server 106 is a “third party” whenever it is not the download server 104 or an edge server 108.) For example, the user may only trust ratings information provided by a certain “kid-friendly” source.

The example of the “kid-friendly” ratings source brings up a more general topic: Not all users will receive the same importance information for a given media presentation. The playlist sent by the download server 104 can be customized for a particular user or for a particular device. As above, demographic information can be gathered about how a media presentation is actually viewed. If possible, this information can be carefully compared to what is known about a particular user (based, for example, on a profile stored on the end-user device 110), and the importance information tailored appropriately. If the end-user device 110 requesting the chunks only has a low resolution screen, then the playlist can be tailored for lower-resolution versions of the media presentation. (Note that in the present discussion, “resolution” is used as a shorthand for any measure of a quality of presentation.) If the user profile indicates a rating limit, then chunks that do not fall within that limit may be sent in censored form or in an alternate form that removes the objectionable content. In some embodiments, the importance information is accompanied by information stating the group for which the importance information is appropriate. The end-user device 110 can then decide whether or not this particular importance information is of interest to it.

Steps 302 through 306 of FIG. 3a present a way to gather importance information that is very particularly customized to the local user of the end-user device 110. In step 302, the end-user device 110 can observe (via its user interface 204) how its user behaves when downloading media presentations. Over time, for example, the end-user device 110 might see that its user usually watches the entireties of taped baseball games but only watches the goals of soccer games. When the user chooses to start viewing another game, the end-user device 110, in step 304, can note the type of game and, based on previous observations, infer whether the entire game is important (baseball) or only the highlights are (soccer).

Many other types of local behavior can be observed and remembered or used in real time. A portion of the media presentation that is fast-forwarded through or skipped can be deemed to be of little importance to this user. Conversely, rewind and slow-motion playback mark a portion as being of special importance. If the user highlights or saves a scene, then it is even clearer that the user finds the scene to be important. Other interactions with the user interface 204 can be used to infer importance. For example, if the user brings up a menu of playback controls, that might indicate that the portion of the media presentation currently being viewed is of greater or lesser importance. In response, the current portion may be marked to be cached locally or a future portion may be downloaded at a lower resolution. Again, if the user increases the volume of playback, that might indicate that the current portion is of greater importance to the user. The potential for “real-time” use of these types of behavioral observations is discussed below in reference to steps 308 of FIG. 3a through step 316 of FIG. 3b.

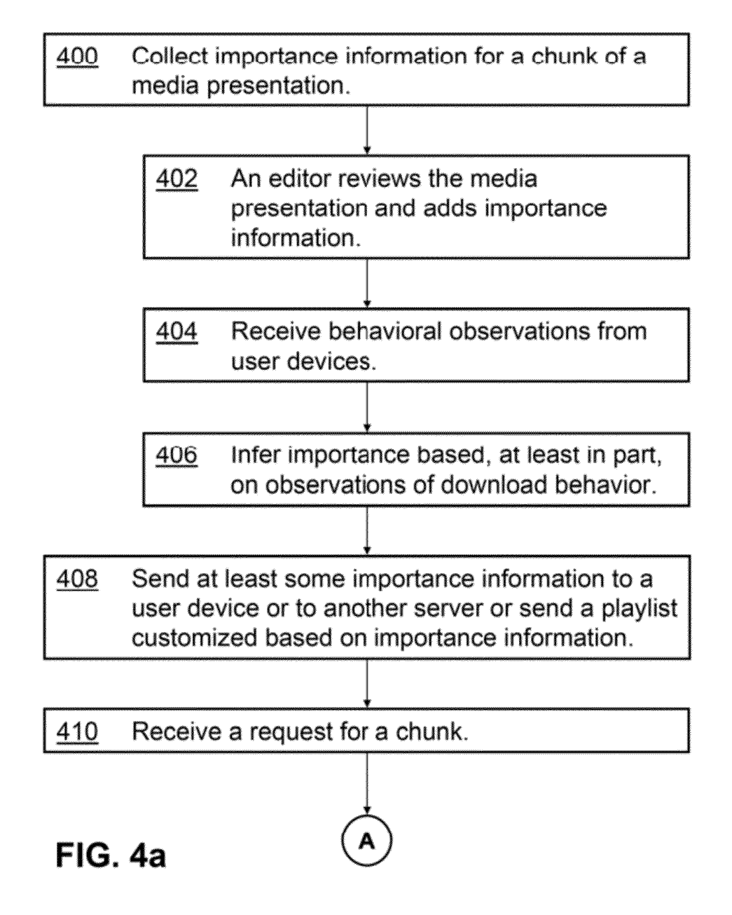

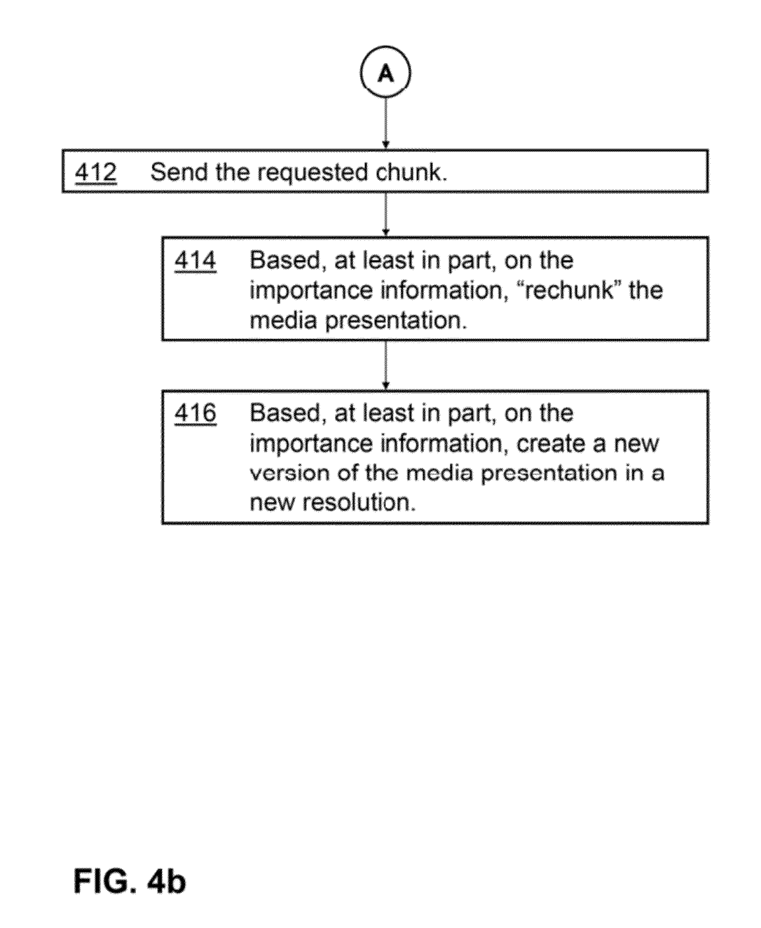

In step 306, the end-user device 110 can, with the permission of its user, report its behavioral observations to a download server 104 or to a third-party server 106. These observations generated by the end-user device 110 are especially important because they can show what portions within a given chunk are deemed to be important and which are not. (Observations collected by the servers 104, 106 themselves are generally made on a chunk-by-chunk basis and cannot look “within” a chunk. See the discussion accompanying step 406 of FIG. 4a below.) The server 104, 106 can add these observations to a collection of demographic statistics. It may also remember the particular user associated with these observations and tailor future importance information accordingly (as by creating a customized playlist, discussed above).

In step 308, the end-user device 110 uses the importance information to decide whether or not to download the chunk. For example, based on either demographic information received from a server 104, 106, 108 or on observations of the local user, the end-user device 110 may decide that it can safely skip over this chunk and then either stop downloading or request an alternative chunk. (In some embodiments, the end-user device 110 presents its decision to skip a chunk to the local user. The local user is given the option of accepting or overriding the decision made by the end-user device 110.) If this chunk is desired, then the end-user device 110 requests it of a server 104, 108, and the server 104, 108 sends the requested chunk. Note that criteria other than importance may be used in the decision of step 308. For example, the end-user device 110 may note that its cache is running low, and thus to avoid a video freeze, it might request a subsequent chunk in low resolution (in order to get that chunk more quickly) even though that chunk is tagged as important and would normally be requested in high resolution. As another example, the end-user device 110 may use the importance information to download a first chunk with low importance at a low resolution so that there is enough time to download a second chunk with high importance at a high resolution without causing a video freeze.

(Note: There is some confusion in the art about the meaning of a “chunk” that is relevant here. Sometimes, a “chunk” is equated with a given time segment of a video presentation, regardless of the coding resolution of that time segment. That is to say, the first two-second segment is a “chunk” that can be encoded at different resolutions. Other times, each resolution of that first two-second segment is considered to be a different “chunk.” The present discussion uses both meanings (the meaning is always clear from the context), but the latter is used when precision is required. Therefore, the decision in step 308 can be to not download this “chunk,” but instead to download a different resolution version of the same segment of the media presentation.)

In some embodiments, the end-user device 110 can, in step 308, work directly with its local user. If the local user wants just the highlights of a media presentation, then the end-user device 110 can review the importance information for the entire presentation, set an importance threshold, make a highlights video containing only those chunks whose importance exceeds the threshold, and offer the highlights video to its local user. At the given importance threshold, the highlights video will run, say, for ten minutes. The local user can then adjust the threshold (possibly without knowing that a threshold is being used) to set the highlights video to a desired length. Thus, simply by applying the importance information, each user can create a highlights video according to his own specifications. A similar service can be provided by the download server 104.

Step 312 of FIG. 3b presents an example of the real-time use of local behavioral observations. If the end-user device 110 notes that its user has been fast-forwarding for a while, then the end-user device 110 may guess that its user will continue to fast-forward. Thus, the end-user device 110 can request the next chunk in low resolution. (Conversely, if the local user is viewing in slow-motion, then a very high resolution chunk can be requested.) If the local user is skipping ahead, then the end-user device 110 can also skip ahead and request a future chunk rather than requesting the very next chunk.

If the end-user device 110 knows that its user is usually interested only in the goals of a soccer game, then the end-user device 110 can, in step 314, request the chunks tagged as goal scenes, even requesting them in high resolution and out-of-order with respect to other chunks (e.g., non-goal scenes that the user is fast-forwarding through). The end-user device 110 can also delay requesting a chunk, waiting for more behavioral information from its user that will help the end-user device 110 to know whether or not that chunk should be requested. For example, if demographic statistics received from a server 104, 106, 108 indicate that the last N chunks of a presentation are not commonly viewed (i.e., viewers usually abort the presentation before the last N chunks are viewed), then the end-user device 110 can delay requesting a download of these chunks while observing the behavior of its local user. If that user does not abort the presentation but continues to watch beyond a certain point, then the end-user device 110 can request the remaining chunks. Alternatively, the end-user device 110 can download the N-th chunk at the lowest resolution possible and delay the download of further chunks until and if the local user starts and continues watching after a certain point of the N-th chunk.

Often, the end-user device 110 will have limited memory and cannot store the entire media presentation. The importance information can then be used by the end-user device 110 to know which chunks to cache because its user may go back and review them (e.g., goals) and which chunks can be discarded immediately after viewing (e.g., the rest of the game).

In step 316, the end-user device 110 renders the chunk to its user via the user interface 204. (In some situations the user interface 204 is used to actually render the chunk on another device, such as when the set-top box 114 renders to the television monitor 116.) Here, the end-user device 110 can use the importance information (often along with local user-interface settings) when deciding how to render this chunk. For example, the end-user device 110 can “pixelate” (a method of obscuring a digital image) to censor scenes tagged as visually offensive or can blur the audio to make offensive language unintelligible. Or, the end-user device 110 can clarify a scene normally obscured. (E.g., the chunk can be encoded to satisfy FCC broadcast standards, standards which need not be followed by the local user, and the end-user device 110 can remove the obscurities, possibly by consulting a third-party server 106 for additional information.) The end-user device 110 might also choose to anticipate its user's wishes by fast-forwarding or skipping to a scene presumably of interest to that user.

Note that the steps of FIGS. 3a and 3b are often repeated, sometimes out of order, during the download of a single media presentation. The behavioral observations gathered in step 302 of FIG. 3a can become more precise and thus more valuable as the user proceeds to view the media presentation. At any time, a server 104, 106, 108 can send updated importance information (e.g., a new, possibly customized, playlist) in step 300.

The method of FIGS. 3a and 3b improves the odds that only what will be of use to the local user is actually downloaded rather than previous methods that simply started downloading everything. Thus, this method can save both bandwidth and battery power for the end-user device 110.

Some embodiments of the present invention provide benefits even if the servers 104, 106, 108 are not enhanced in any way over the known art. (That is, the end-user device 110 only has access to the importance information that it can infer from observations of its user's behavior in step 302 of FIG. 3a.) However, embodiments in which the servers 104, 106, 108 are enhanced to deliver more importance information provide clear advantages.

FIGS. 4a and 4b provide an example of such an enhanced server 104. In step 400 of FIG. 4a, the server 104 collects importance information and associates that information with chunks of a media presentation. As discussed above in the text accompanying FIG. 3a, this information may be supplied by an editor (human or electronic) (step 402), may include demographic statistics, may be received from the end-user device 110 itself (step 404), and may be stored on the download server 104 itself or may be stored on a third-party server 108. In addition, the download server 104 can observe itself (step 406) and see what chunks are requested, how often, etc., and can infer its own estimate of importance. (These observations are parallel to the other gathered demographic statistics.)

In some embodiments of step 408, the server 104 sends at least some importance information (or links to importance information stored elsewhere) to a client device. (The end-user device 110 is one type of client device, but there are others, as discussed below.) The importance information may be included in a playlist, either generic or customized, as discussed above. In other embodiments of step 408, the server 104 does not actually send the importance information but instead creates and sends a customized playlist based on the importance information. A customized playlist might include only those chunks that meet the appropriateness criteria of a user profile stored on the end-user device 110 or might include substitute, non-objectionable, chunks for those chunks deemed objectionable. Note that step 408 can be repeated during the download of a media presentation as updated importance information becomes available.

In some embodiments, an alternative step 408 can be used with legacy end-user devices 110. These are devices that do not know about importance information. The server 104, knowing the limitations of this particular end-user device 110, can, instead of sending out importance information that will simply be ignored, use the importance information to tailor a version of the playlist for this particular end-user device 110. The results as perceived by the user of the end-user device 110 will roughly approximate the results obtainable by an end-user device 110 that is fully cognizant of the importance information.

In steps 410 and 412, the server 104 receives a request for a chunk from a client device and fulfills that request by downloading the requested chunk. Most systems today are “pull” systems where the client device actually makes the decision about what to download (in step 308 of FIG. 3a), and the server 104 just does as it is told. However, “push” systems are possible where the server 104 has more control over what chunks are downloaded. Aspects of the present invention can be easily modified by one of ordinary skill in the art to apply to push systems, when that becomes desirable.

In some situations, the gathered importance information can lead the server 104 to decide that the present chunking is not the most efficient. For example, it may be discovered that half of a ten-second chunk is very important, but the other half is rarely viewed. This leads to inefficiencies because most (but not all) current systems can only download on a chunk-by-chunk basis and cannot deliver only part of a chunk. To alleviate this inefficiency, the server 104 can, in step 414 of FIG. 4b, “rechunk” the media presentation so that each new chunk has a relatively constant level of importance throughout that chunk. (Of course, that is only one consideration, and there comes a point at which rechunking would produce inefficiencies of its own that outweigh the advantages.) In another example, some download protocols recommend that a specific number of chunks at the beginning of a media presentation always be downloaded. Based on demographics, the server 104 can rechunk the beginning of a presentation so that the required number of chunks corresponds to what users usually watch. When the importance information is collected by the server 104 and is therefore based on observations collected on a chunk-by-chunk basis, the server 104 can improve the chunking of the presentation through an evolutionary approach in which it attempts different chunking alternatives at different times and chooses the most efficient chunking alternative. As an example, the server 104 starts with chunking alternatives that involve shorter chunks and then aggregates the chunks until a certain criterion of relative importance is met.

Similar to the situation in step 414, the server 104 may, in step 416, decide that a whole new version of the media presentation (or parts of the media presentation) should be provided at a new resolution. That is, scenes often subject to extensive fast-forwarding or skipping may be recoded to make them available at a low resolution, while oft-viewed scenes may be provided at a high resolution.

As with the method of FIGS. 3a and 3b, the method of FIGS. 4a and 4b is often repeated, with some steps out-of-order or skipped.

For the sake of clarity, the discussion of the method of FIGS. 4a and 4b focuses on the download server 104. Much of this method can also be applied to a third-party server 106. The third-party server 106 can gather importance information (steps 400, 402, and 404), can infer importance from its own downloads (step 406) (even though the third-party server 106 is downloading importance information rather than media content), and send (possibly updated or customized) importance information to client devices (step 408).

In reference to step 408 of FIG. 4a, it is mentioned that the server 104 can download to client devices other than the end-user device 110. In particular, the server 104 can download media content and importance information to an “edge” server 108 (also called an “edge proxy” server). Edge servers 108 are often provided to ease download congestion from the servers 104. The servers 104 send popular media content to the edge servers 108 which in turn respond directly to the download requests of end-user devices 110 (step 310 of FIG. 3a). When a request is made for content not currently cached on the edge server 108, either the request is passed along to a download server 104, or the edge server 108 retrieves the content from the download server 104 and then fulfills the request.

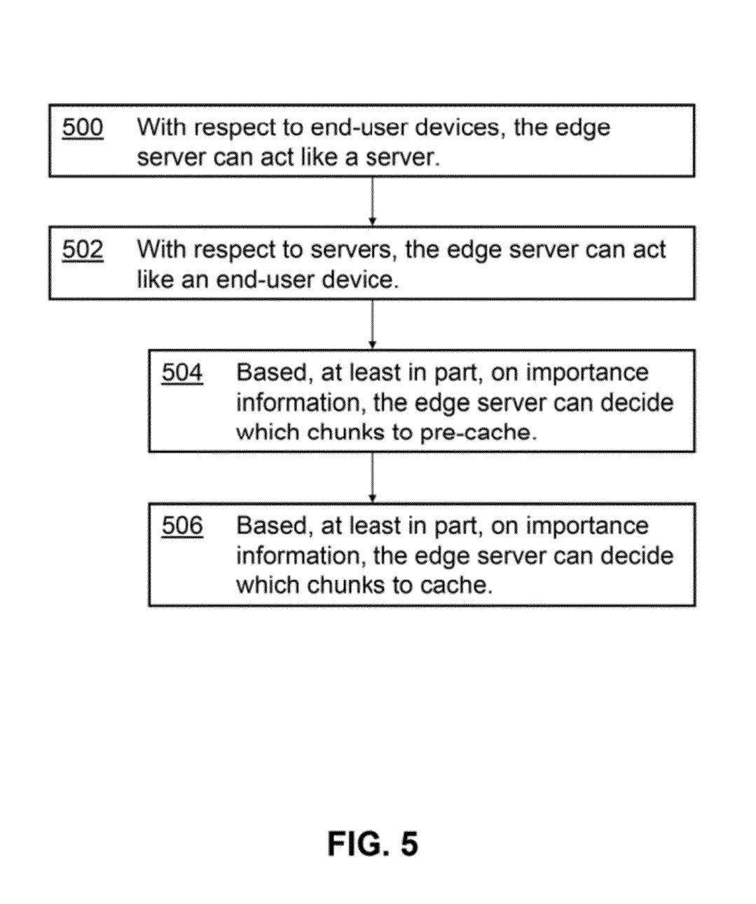

In accordance with aspects of the present invention, FIG. 5 presents a simplified method usable by an edge server 108. It should be noted that some embodiments of the present invention work perfectly well with the edge servers 108 already known in the art. On the one hand, step 500 summarizes the role of the edge server 108 with respect to the end-user device 110. That is, the edge server 108 acts like a download server 104 (and even, in some embodiments, like the third-party server 106) to provide content to the end-user device 110. Thus, the edge server 108 can perform the steps of the server method as illustrated in FIGS. 4a and 4b.

On the other hand, step 502 summarizes the role of the edge server 108 with respect to download servers 104 (and, in some embodiments, with respect to third-party servers 106). That is, the edge server 108 can perform the steps of the end-user device method as illustrated in FIGS. 3a and 3b. (In general, an edge server 108 does not directly support a local user, so it is unlikely that the edge server 108 will ever perform step 316 of FIG. 3b).

The edge server 108 does not perform entirely at the whim of the servers 104, 106 and of the end-user device 110. In step 504, the edge server 108 can use importance information (either given to it or inferred by it) to decide which chunks to “pre-cache,” that is, which chunks to request from the download server 104 and store even before they are requested by an end-user device 110. For example, it can be decided up front that the highlights of a championship game are going to be pretty popular download targets. Then, rather than waiting for the first requests from end-user devices 110 to come in, the edge server 108 can store these highlights immediately, thus making its response to the first requests quicker than if it had to retrieve the highlights only upon the first request.

Similarly, in step 506, the edge server 108 can use importance information and can also observe the download behavior it is seeing and decide which chunks are popular enough to keep in its somewhat limited cache (and, conversely, which chunks can be deleted to make room for others). Note that this decision can be made independent of, and even counter to, the demographic statistics gathered by the download server 104 and third-party server 106. That is because the edge server 108 is seeing a more localized population whose tastes may differ from those of the more general population seen by the servers 104 and 106.

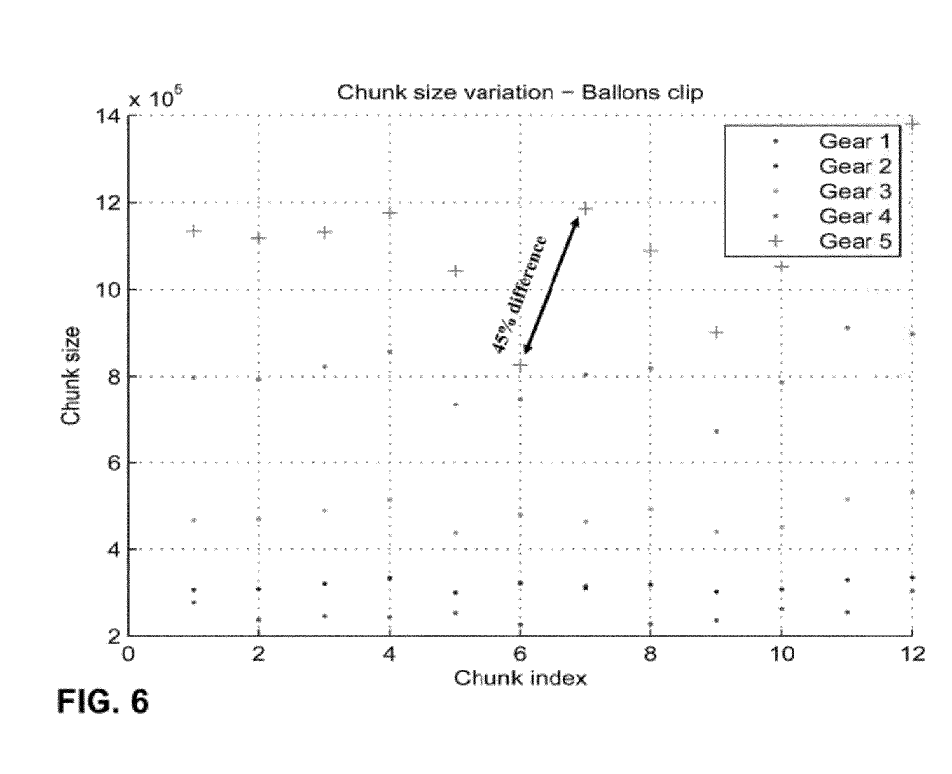

Some embodiments of the present invention use chunk-size information in addition to, or instead of, importance information to increase the efficiency of downloads. Because the chunks that make up a media presentation are generally all of the same play length (e.g., each chunk represents two seconds of the presentation), one might think that all of the chunks contain the same number of bytes (for a given resolution, of course). That assumption is, however, often not true because the encoding efficiency can vary throughout the presentation due to changes in the complexity of the scene being viewed and how rapidly the scene is changing. FIG. 6 illustrates this variance of encoding efficiency with statistics taken from an actual video clip. Paying attention only to “Gear 5” (the highest resolution illustrated in FIG. 6), the figure shows that chunk 7 actually needs 45% more bytes than chunk 6 to encode the same temporal amount of the video clip.

While this variance in encoding efficiency has long been known in the art, end-user devices have not been able to intelligently handle the variance. Prior-art end-user devices had to assume that all of the chunks in one media presentation are of the same size (for a given resolution). It is quite possible that when an upcoming chunk is much larger than the assumed size (e.g., chunk 7 of FIG. 6), the end-user device's input buffers will run “dry” before the chunk is fully loaded, leading to video freeze.

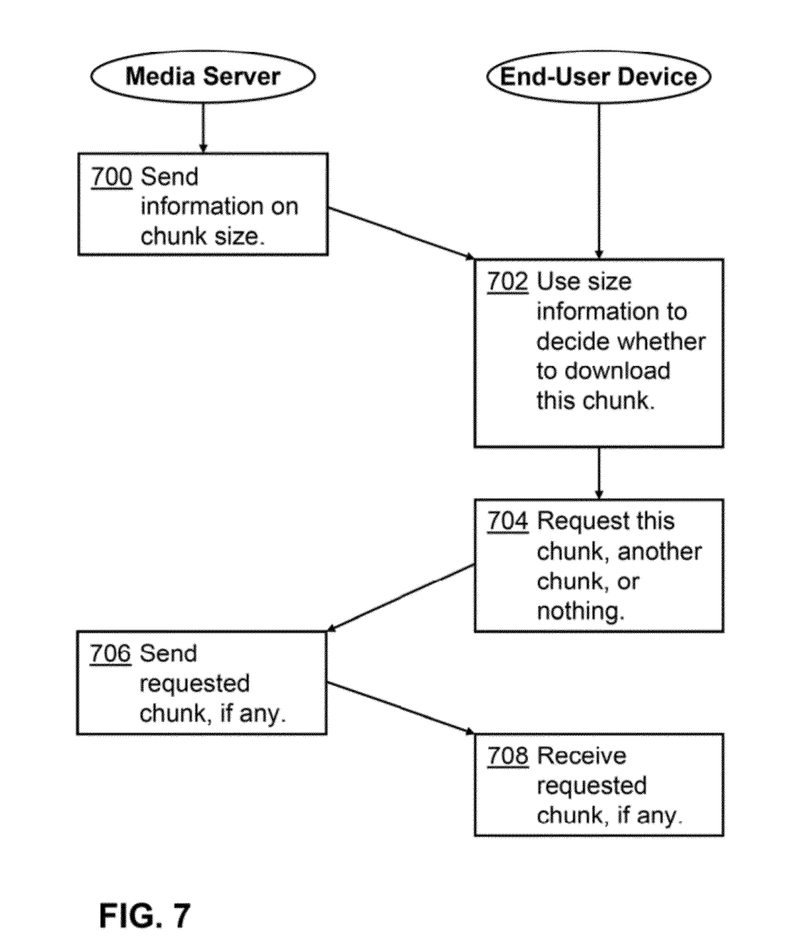

FIG. 7 presents a method to avoid at least some of these video-freeze situations. In step 700, a server 104, 106, 108 sends chunk-size information to the end-user device 110. The chunk-size information can be encoded in the playlist, for example, or included with initial metadata associated with the media presentation, or the size of a given chunk can be included along with a previously downloaded chunk. In some situations, the server 104, 106, 108 is acting in response to an explicit request for chunk-size information sent by the end-user device 110. For example, the end-user device 110 can send an HTTP HEAD command requesting size information for the next chunk, or for various chunks in the media presentation at a given resolution, or for various chunks at various resolutions. To save bandwidth, some embodiments, rather than sending the actual size of a chunk, send an approximation of the size or a relative size. In some embodiments, the server 104, 106, 108 publishes a “reference” value (e.g., the maximum bit rate) for a media presentation (at a given resolution) and then, for each chunk, gives the size (or percentage) relative to that reference value.

In step 702, the end-user device 110 reviews the chunk-size information. For example, the end-user device 110 can continuously analyze the performance of its network link. Based on that analysis, the end-user device 110 can estimate how long it should take to download the next chunk, given the size of that chunk. The end-user device 110 can decide that it is unlikely that the next chunk can be downloaded in time. Then, to avoid the possibility of a video freeze, the end-user device 110 could, in step 704, request the next chunk at a lower resolution (that is, with a smaller chunk-size). In some situations, the end-user device 110 may decide to request a completely different chunk or not request any chunk at all.

In some situations, the chunk-size information and the importance information are both available to the end-user device 110 which can use both types of information to decide what to do in step 702.

If in step 704, the end-user device 110 requests a chunk, then the server 104, 106, 108 provides that chunk in step 706.

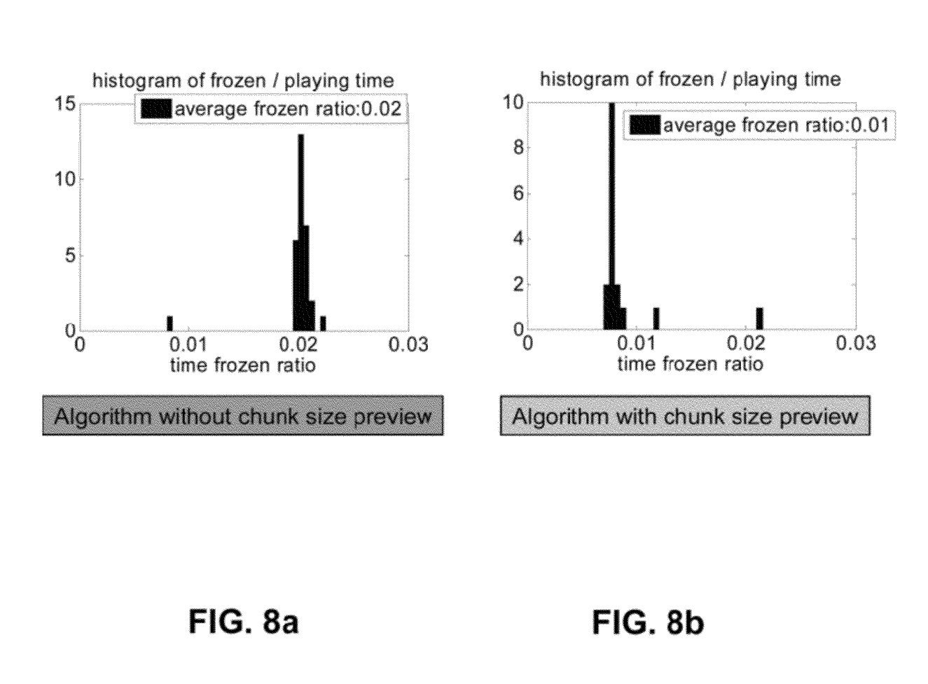

FIGS. 8a and 8b present experimental results. In FIG. 8a, a prior-art end-user device does not have access to actual chunk-size information and, in consequence, endures a video freeze ratio of 0.02. In FIG. 8b, an end-user device 110 acting according to aspects of the present invention uses the provided chunk-size information to reduce the video freeze ratio to only 0.01.

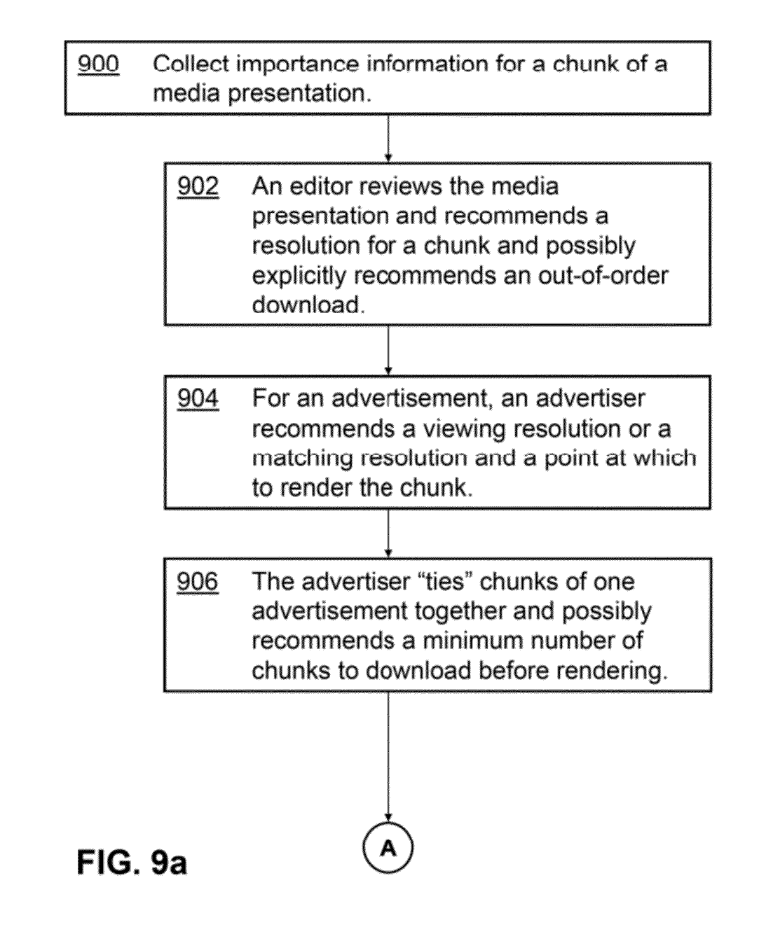

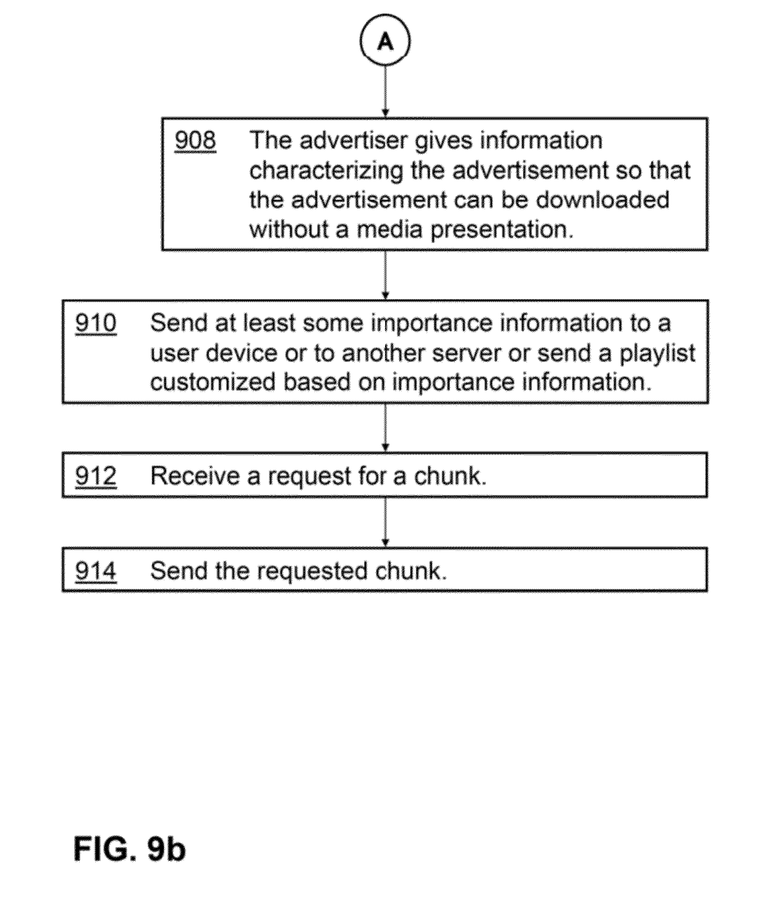

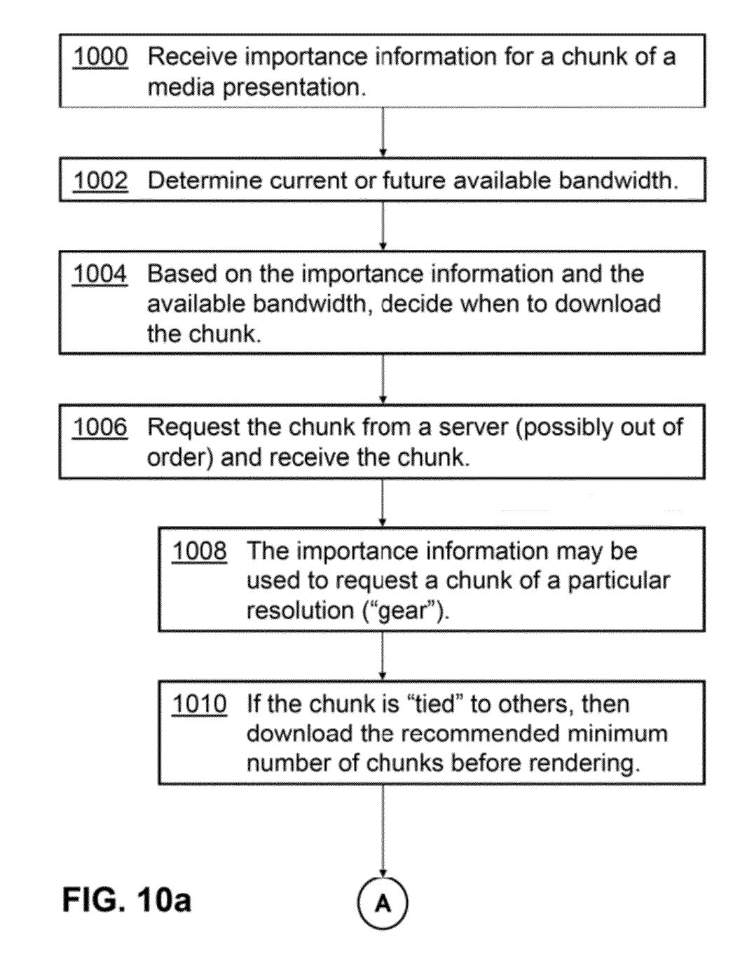

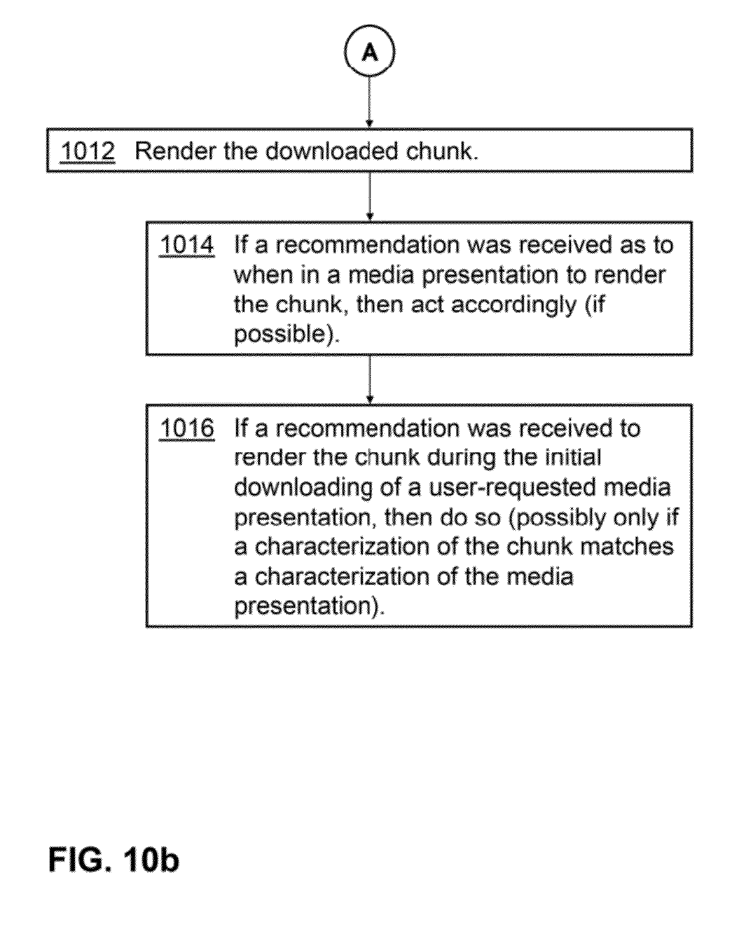

Other examples of the use of importance information are illustrated in FIGS. 9 and 10. Here, importance information is used to answer the end-user device's question “When should I download the chunk?”

(Note that the methods of FIGS. 9 and 10 can be practiced in conjunction with the other methods discussed above. That is to say, the importance information discussed above can also be present and considered here. To avoid prolixity, issues discussed above are not repeated here.)

FIGS. 9a and 9b present a method for the server 104. In step 900 of FIG. 9a, the server 104 collects importance information and associates that information with chunks of a media presentation. For example, in step 902 an editor views a media presentation and decides that some chunks are more important than others, for example a goal in a soccer game. (See the discussion of step 402 of FIG. 4a above.) In the importance information for the chunk containing the goal, the server 104 includes a recommended resolution for viewing that chunk. The recommendation may be of a minimum resolution, a maximum resolution, a specific resolution determined by the server 104 to be the best for viewing the chunk, or even a required resolution. (The required resolution is discussed below in reference to step 904.)

Because it takes longer to download a high-resolution version of a chunk than a low-resolution version, the server 104 may include, in the importance information for this chunk, an explicit recommendation that the end-user device 110 start downloading this chunk out-of-order, using any available bandwidth. This helps ensure that the high-resolution chunk is available when its time for viewing arrives.

In an example very different from the soccer goal discussed above, an advertisement can be downloaded within a user-requested media presentation. (But also see the discussion of step 908 of FIG. 9b below.) The advertiser naturally wishes the advertisement to be fully appreciated by the end user, so, in step 904, the advertiser recommends a resolution for the advertisement chunk. The advertiser may even require that a specific resolution be used. In some embodiments, the server 104 can determine an appropriate resolution as, for example, when the advertisement contains text that should be readable. In any case, the importance information for the advertisement chunk includes a recommended resolution just as did the soccer-goal chunk. The importance information can also state that the advertisement should be played at the same resolution as the media-presentation chunks surrounding it, to make the advertisement fit in visually with what the end user is watching.

(It should be noted that in some embodiments, the end-user device 110 is not told which particular chunks are advertisements and which are part of the requested media presentation. This is a consequence of the “pull” nature of these embodiments.)

Although advertisement chunks are downloaded in the same fashion as are the chunks of the user-requested media presentation, the advertisements are clearly not a part of that media presentation. A consequence of this is that, unlike a soccer goal, an advertisement does not have a “natural” place within the media presentation. Thus, the advertiser (or the server 104 working independently) can add to the importance information for the advertisement chunk a recommendation for when to play the advertisement (step 904). For example, scene changes in the media presentation can be noted (by a human or an electronic editor), and the recommendation made that the advertisement be played right after the chunk ending the current scene. A time range can also be given. For example: “Play this advertisement at a time decided on by the end-user device 110, but certainly within the next five minutes.”

Another consequence of the fact that the advertisement is not a part of the user-requested media presentation is illustrated in step 906. The advertisement is really a media presentation unto itself and may include a number of chunks. To prevent a video freeze at the end-user device 110 when playing the advertisement, the importance information notes how many chunks are in this advertisement and includes a recommendation of a minimum number of chunks to download before beginning the rendering of the advertisement.

Step 908 of FIG. 9b pushes the distinction between the advertisement and the user-requested media presentation even further. Here, the importance information for the advertisement chunks recommends that the end-user device 110 download these chunks even if it is not currently downloading a media presentation. The point is to “pre-cache” advertisements by taking advantage of otherwise unused bandwidth. This possibility is discussed in greater detail below from the viewpoint of the end-user device 110 in reference to step 1016 of FIG. 10b.

The remainder of the method of FIG. 9b matches that discussed above in relation to FIGS. 4a and 4b. The server 104 provides the importance information to the end-user device 110 (step 910), and when the end-user device 110 requests a chunk (step 912), the server 104 provides it (step 914).

In the method of FIGS. 10a and 10b, the end-user device 110 receives (step 1000 of FIG. 10a) the importance information provided by the server 104 and responds accordingly. In step 1002, the end-user device 110 determines either its presently available bandwidth or the bandwidth it expects to have in the near future. Based on that determination and on the received importance information, the end-user device 110 plans, in step 1004, when to download the chunk. Here, “when” refers to the order in which the chunks are requested. If it is at all possible, the end-user device 110 requests higher-resolution chunks before it requests some lower-resolution chunks that will be rendered earlier.

The decision process for determining when to download a chunk is complicated by the many different types of importance information that may be available. In a very simple case, a soccer goal chunk is marked with a recommended resolution. The goal chunk has a definite time within the media presentation at which it should be rendered; the end-user device 110 knows the size of the goal chunk at the recommended resolution and has determined its available bandwidth. The end-user device 110 may simply put these numbers together to decide when it should request the goal chunk. (A potential complication comes when the available bandwidth is so low that downloading the intervening chunks before the goal chunk may prevent the end-user device 110 from downloading the goal chunk in a timely manner.)

When the chunk is an advertisement, the importance information might include a number of recommended times at which to render the chunk (e.g., at any one of the next few scene changes in the media presentation). Thus, the end-user device 110 can balance current download needs and schedule the download of the advertisement chunk a little further in the future, knowing that the advertisement should be received before at least one of the recommended playing times.

If the recommendation is made to render the advertisement in a resolution that matches that of the chunks of the user-requested media presentation that will surround it, then the end-user device 110 has some flexibility: It might change the resolution it is requesting for the media-presentation chunks if that ensures that the advertisement chunks will arrive in time.

Step 1010 considers the case when chunks are “tied” together, e.g., an advertisement includes multiple chunks. The end-user device 110 now may need to schedule the download not of one chunk, but of the minimum recommended number of tied-together chunks, making sure that they arrive before a recommended time for rendering the advertisement.

Based on the above considerations, the end-user device 110 requests the chunk (step 1006) at an appropriate resolution (step 1008) (see also the discussion above in reference to steps 902 and 904 of FIG. 9a).

With the chunk in hand, the end-user device 110 decides when to render it (step 1012 of FIG. 10b). For the soccer-goal chunk, the decision is easy: Render the chunk when the user gets to that point in the soccer game. For an advertisement with one or more recommended rendering times, then try to render the advertisement at an appropriate time (step 1014).

Step 1016 considers the case where a recommendation is made to render the downloaded advertisement before a user-requested media presentation is ready to start playing. That is, the advertisement is downloaded early so that it can be played while the initial chunks of the user-requested media presentation are still being downloaded. The advertisement might have been downloaded hours earlier during periods of low bandwidth use (e.g., when the user is on a telephone call or browsing the web or when the end-user device 110 is idle) and held in the memory of the end-user device 110 until needed.

Step 1016 also applies while the final chunks of a user-requested media presentation are being rendered. Because the media presentation has already been fully downloaded, the end-user device 110 can take advantage of the unused bandwidth to download another advertisement to be played in the future.

Because the advertisement is not downloaded during the download of the media presentation, care should be taken to make sure that the advertisement is displayed during an appropriate media presentation. The advertisement's importance information can include a characterization of the advertisement, and the end-user device 110 can compare that characterization to a characterization of the media presentation. If they match, then the advertisement can be rendered. Otherwise, another advertisement may be rendered while this one is held ready for a more appropriate time. Known techniques such as data mining, user profiling, and analysis of past user activity can be used to match advertisements with suitable media presentations. These techniques can also be used to determine which advertisements to download. The importance information can include a time setting stating how long the advertisement should be retained while it is waiting to be played.

In view of the many possible embodiments to which the principles of the present invention may be applied, it should be recognized that the embodiments described herein with respect to the drawing figures are meant to be illustrative only and should not be taken as limiting the scope of the invention. For example, aspects of the present invention may be particularly useful in adaptive-streaming environments, but the invention is not limited to these environments. Aspects of the present invention are not limited to any particular implementing data-networking protocols or to particular server and end-user device deployments. Therefore, the invention as described herein contemplates all such embodiments as may come within the scope of the following claims and equivalents thereof.

We claim:

1. A method for an end-user device to receive media content, the method comprising:
receiving, by the end-user device, importance information for a chunk of a media presentation;
determining, by the end-user device, an amount of available bandwidth;
deciding, by the end-user device, when to request the chunk of the media presentation, wherein the deciding is based, at least in part, on the importance information for the chunk of the media presentation and on the determined available bandwidth; and
upon deciding when to request the chunk of the media presentation:
sending, by the end-user device, a request for the chunk of the media presentation; and
receiving, by the end-user device, the requested chunk of the media presentation.

2. The method of claim 1 wherein the end-user device is selected from the group consisting of: a mobile telephone, a set-top box, a digital video recorder, a personal computer, a home gateway, a media-restreaming device, a kiosk, and a digital sign.

3. The method of claim 1 wherein receiving the importance information comprises an element selected from the group consisting of: receiving a playlist from a server and receiving importance information from a third-party server.

4. The method of claim 1 wherein the importance information comprises an element selected from the group consisting of: assigned importance, a link to further importance information, a recommended resolution for the chunk, a recommendation for a point in the media presentation at which to render the chunk, a recommendation that the chunk be rendered at a resolution matching that of another chunk in the media presentation, an indication that the chunk is a member of a set of chunks, the set of chunks comprising at least one other chunk, a recommendation that the chunk be downloaded out-of-presentation-order with respect to other requests sent, by the end-user device, for other chunks of the media presentation, and a recommendation that the chunk be rendered while the end-user device is receiving chunks of another media presentation.

5. The method of claim 4 wherein the recommended resolution for the chunk comprises an element selected from the group consisting of: a minimum recommended resolution, a maximum recommended resolution, a specific recommended resolution, and a required resolution.

6. The method of claim 1 wherein determining an amount of available bandwidth comprises an element selected from the group consisting of: measuring a current amount of available bandwidth and predicting a future amount of available bandwidth.

7. The method of claim 1 wherein sending a request for the chunk of the media presentation comprises sending the request out-of-presentation-order with respect to other requests sent, by the end-user device, for other chunks of the media presentation.

8. The method of claim 1 further comprising:
receiving, by the end-user device, a minimum recommended resolution for the chunk;
wherein the sending a request is based, at least in part, on the minimum recommended resolution and on a resolution of another chunk in the media presentation received by the end-user device.

9. The method of claim 1 further comprising:
receiving, by the end-user device, a recommendation for a point in the media presentation at which to render the chunk; and
rendering, by the end-user device, the chunk at the recommended point in the media presentation.

10. The method of claim 9 wherein the recommendation for a point at which to render the chunk comprises an element selected from the group consisting of: a time range and another chunk in the media presentation after which to render the chunk.

11. The method of claim 1 further comprising:
receiving, by the end-user device, a recommendation that the chunk be rendered at a resolution matching that of another chunk in the media presentation;
wherein the sending a request is based, at least in part, on a resolution of another chunk in the media presentation received by the end-user device.

12. The method of claim 1 further comprising:
receiving, by the end-user device, an indication that the chunk is a member of a set of chunks, the set of chunks comprising at least one other chunk;
receiving, by the end-user device, a recommended minimum number of chunks in the set; and
beginning to render the chunks in the set only after receiving at least the recommended number of chunks in the set.

13. The method of claim 1 further comprising:
receiving, by the end-user device, a recommendation that the chunk be rendered while the end-user device is receiving chunks of another media presentation; and
rendering, by the end-user device, the chunk while the end-user device is receiving chunks of another media presentation.

14. An end-user device configured for receiving media content, the end-user device comprising:
a network interface configured for receiving importance information for a chunk of a media presentation; and
a processor operatively connected to the network interface and configured for:
determining, by the end-user device, an amount of available bandwidth;
deciding, by the end-user device, when to request the chunk of the media presentation, wherein the deciding is based, at least in part, on the importance information for the chunk of the media presentation and on the determined available bandwidth; and
upon deciding when to request the chunk of the media presentation:
sending, by the end-user device, a request for the chunk of the media presentation; and
receiving, by the end-user device, the requested chunk of the media presentation.

15. The end-user device of claim 14 wherein the end-user device is selected from the group consisting of: a mobile telephone, a set-top box, a digital video recorder, a personal computer, a home gateway, a media-restreaming device, a kiosk, and a digital sign.

16. A method for a server to deliver media content, the method comprising:
sending, by the server to a client device, an element selected from the group consisting of: importance information for a chunk of a media presentation and a playlist for the media presentation, the playlist based, at least in part, on importance information;
receiving, by the server from the client device, a request for the chunk of the media presentation; and
sending, by the server to the client device, the requested chunk of the media presentation;
wherein the importance information comprises an element selected from the group consisting of: a recommended resolution for the chunk, a recommendation for a point in the media presentation at which to render the chunk, a recommendation that the chunk be rendered at a resolution matching that of another chunk in the media presentation, a recommendation that the chunk be downloaded out-of-presentation-order with respect to other requests received, from the client device, for other chunks of the media presentation, and a recommendation that the chunk be rendered while the client device is receiving chunks of another media presentation.

17. The method of claim 16 wherein the recommended resolution for the chunk comprises an element selected from the group consisting of: a minimum recommended resolution, a maximum recommended resolution, a specific recommended resolution, and a required resolution.

18. The method of claim 17 further comprising:
analyzing, by the server, the chunk to determine the minimum recommended resolution for the chunk.

19. The method of claim 16 wherein the recommendation for a point at which to render the chunk comprises an element selected from the group consisting of: a time range and another chunk in the media presentation after which to render the chunk.

20. The method of claim 16 wherein the importance information further comprises an indication that the chunk is a member of a set of chunks, the set of chunks comprising at least one other chunk.

21. The method of claim 16 further comprising:
analyzing, by the server, the media presentation to determine the recommended point in the media presentation at which to render the chunk.

22. A server configured for sending media content, the server comprising:
a network interface configured for sending an element selected from the group consisting of: importance information for a chunk of a media presentation and a playlist for the media presentation, the playlist based, at least in part, on importance information; and
a processor operatively connected to the network interface and configured for:
receiving, from a client device via the network interface, a request for the chunk of the media presentation; and
sending, to the client device via the network interface, the requested chunk of the media presentation;
wherein the importance information comprises an element selected from the group consisting of: a recommended resolution for the chunk, a recommendation for a point in the media presentation at which to render the chunk, a recommendation that the chunk be rendered at a resolution matching that of another chunk in the media presentation, a recommendation that the chunk be downloaded out-of-presentation-order with respect to other requests received, from the client device, for other chunks of the media presentation, and a recommendation that the chunk be rendered while the client device is receiving chunks of another media presentation.

23. The server of claim 22 wherein the processor is further configured for:
analyzing the media presentation to determine the recommended point in the media presentation at which to render the chunk.
